(19) United States
(12) Patent Application Publication
(10) Pub. No.: US 2008/0263808 A1
(43) Pub. Date: Oct. 30, 2008

(54) Windscreen Wiper Device

(75) Inventor: Armin Stubner, Buehl-Altschweier (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/158,801

(22) PCT Filed: Nov. 15, 2006
(86) PCT No.: PCT/EP06/68507

§ 371 Date: Jun. 23, 2008

(30) Foreign Application Priority Data
Dec. 28, 2005 (DE) 10 2005 062 778.1

(51) Int. Cl. B60S 1/08

(52) U.S. Cl. 15/250.16

(57) ABSTRACT

The invention relates to a windscreen wiper device, in particular for a motor vehicle, comprising at least one gear wheel (13), a gear housing (11) and a gear (10) that has a park position switch (12). Up to now the setting of a motor crank to a specific park position has only been possible if the gear housing cover has been fitted. To solve this problem, in the windscreen wiper device according to the invention, the park position switch (12) is situated between the gear wheel(s) (13) and the gear housing (11).

### BACKGROUND OF THE INVENTION

The invention relates to a windscreen wiper device, in particular for a motor vehicle, comprising at least one gear wheel, a gear housing and a gear comprising a park position switch.

In the previously known windscreen wiper devices, the park position switch is arranged between the gear wheel and a gear housing cover. The setting of a motor crank to a specific park position has only been possible until now when the gear housing cover was fitted, i.e. when the gear housing was closed, or in gears which have a gear cover with a closable opening in the region of a drive shaft. Therefore, a connection between the gear wheel and a shaft was only possible by connections which did not require a thrust bearing for producing the connection on a shaft end facing the gear cover, such as for example screw connections. Screw connections, however, are very costly.

### SUMMARY OF THE INVENTION

The object of the invention is to improve a windscreen wiper device of the aforementioned type such that in future the connection between the shaft of the at least one gear wheel and the motor crank may be carried out in a cost-saving manner.

The invention solves the problem set forth with a windscreen wiper device of the aforementioned type, in which according to the invention the park position switch is arranged between the at least one gear wheel and the gear housing. Thus in the future, the setting of a motor crank to a specific park position, may take place even when the gear housing cover is not fitted, i.e. when the gear housing is still open. Thus when the gear housing cover is open, the motor crank and a shaft connected to the gear wheel may be caulked to one another, whereby costs are reduced. A cost-effective and easily automated option for the connection is a wobble process.

The park position switch may be implemented in a very space-saving and also cost-effective manner when on the at least one gear wheel a contact disk or a contact layer is provided opposite the gear housing. As the contact disk or the contact layer only require very little space, the dimensions of the gear housing may be markedly reduced.

At least two sliding contacts may bear against the contact disk, which are mechanically connected to the gear housing. As the sliding contacts also only require very little space, they also contribute to the small dimensions of the gear housing. Moreover, the sliding contacts are an option for a very cost-effective construction to produce an electrical contact.

In a further preferred embodiment, the park position switch may have a microswitch which is arranged between the at least one gear wheel and the gear housing. The microswitch is also a space-saving alternative which allows smaller dimensions of the gear housing.

It is very simple and thus cost effective but also space-saving when a projection activating the microswitch is attached to the at least one gear wheel.

For reliable actuation of the microswitch, the microswitch may have an actuating element which may be actuated by the projection attached to the at least one gear wheel.

The shaft connected to the at least one gear wheel may be mountable at one end in the gear housing and at the other end in the gear housing cover. As a result, a gear of very low profile is possible, for which the park position switch according to the invention is very suitable, particularly due to its space-saving construction.

### BRIEF DESCRIPTION OF THE DRAWINGS

Various embodiments are described in more detail hereinafter with reference to the accompanying drawings, in which in detail:

FIG. 1 shows a sectional view through a first embodiment of a gear;

FIG. 2 shows a sectional view through a second embodiment of a gear.

### DETAILED DESCRIPTION

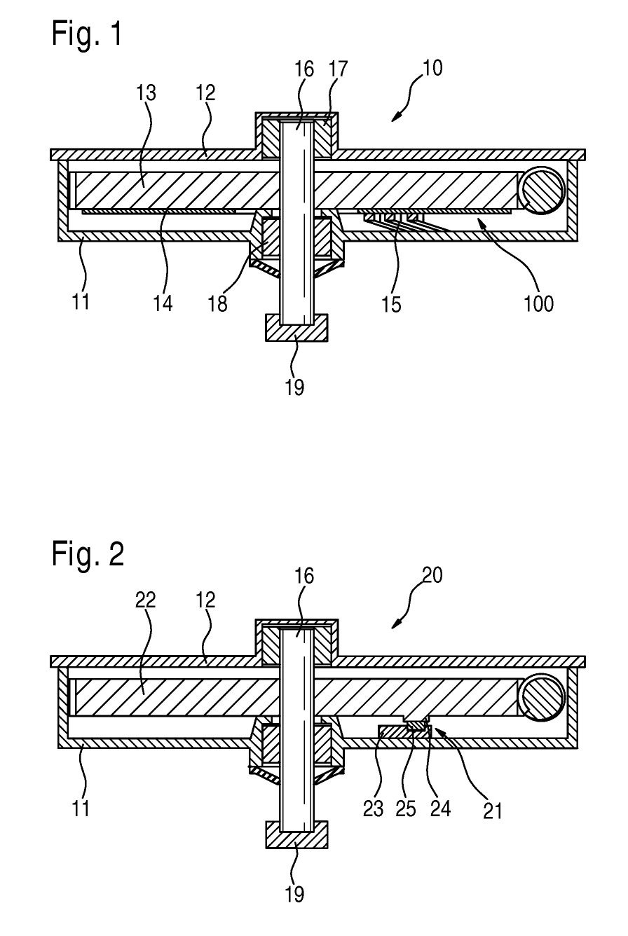

FIG. 1 shows a gear 10 comprising a gear housing 11 and a gear housing cover 12. A shaft 16 connected to a gear wheel 13 is mounted in bearing bushes 17 and 18. As the bearing bushes 17 and 18 are arranged in the gear housing 11 and in the gear housing cover 12, the gear 10 may be of relatively low profile construction.

A park position switch 100 is arranged between the gear wheel 13 and the gear housing 11. By the choice of mounting location of the park position switch 100 between the gear wheel 13 and the gear housing 11 it is possible to set a motor crank 19 to a specific park position, even when the gear housing cover 12 is not fitted, i.e. when the gear housing 11 is still open.

The open gear housing 11, moreover, allows the shaft 16 to be connected to the motor crank 19 by caulking. In this manner, assembly costs and assembly times may be reduced, in particular when the shaft 16 is connected to the motor crank 19 by a wobble process.

The park position switch 100 has a contact disk 14 and sliding contacts 15 bearing against the contact disk 14. The contact disk 14 and the sliding contacts 15 bearing thereagainst, permit a low profile construction of the park position switch 100 and thus of the gear 10.

FIG. 2 shows a gear 20 with a park position switch 21. The park position switch 21 is also arranged between the gear housing 11 and a gear wheel 22.

The park position switch 21 comprises a microswitch 23 and a projection 24 provided on the gear wheel 22. Moreover, the microswitch 23 is provided with an actuating element 25.

When, therefore, the projection 24 comes into contact with the actuating element 25, the microswitch 23 is thus activated.

The microswitch 23 and the projection 24 and the actuating element 25 only require minimal constructional space, so that said embodiment is also very well suited for low profile gear housings 20.

Even in this variant it is possible when the gear cover 12 is open to set the motor crank 19 to the defined park position. Said variant is also suitable for caulking the shaft 16 and the motor crank 19 to one another.

1. A windscreen wiper device, comprising at least one gear wheel (13, 22), a gear housing (11) and a gear (10, 20) comprising a park position switch (12, 21), characterized in that the park position switch (12, 21) is arranged between the at least one gear wheel (13, 22) and the gear housing (11).

2. The windscreen wiper device as claimed in claim 1, characterized in that the park position switch (12) comprises a contact disk (14) or contact layer arranged on the at least one gear wheel (13), which is arranged opposite the gear housing (11).

3. The windscreen wiper device as claimed in claim 2, characterized in that at least two sliding contacts (15) bear against the contact disk (14), which are mechanically connected to the gear housing (11).

4. The windscreen wiper device as claimed in claim 1, characterized in that the park position switch (21) has a microswitch (23) which is arranged between the at least one gear wheel (22) and the gear housing (11).

5. The windscreen wiper device as claimed in claim 4, characterized in that a projection (24) activating the microswitch (23) is attached to the at least one gear wheel (22).

6. The windscreen wiper device as claimed in claim 4, characterized in that an actuating element (25) is provided on the park position switch (23).

7. The windscreen wiper device as claimed in claim 1, characterized in that a shaft (16) connected to the at least one gear wheel (13, 22) is mountable at one end in the gear housing (11) and at the other end in a gear housing cover (12).

8. The windscreen wiper device as claimed in claim 5, characterized in that an actuating element (25) is provided on the park position switch (23).

9. The windscreen wiper device as claimed in claim 6, characterized in that a shaft (16) connected to the at least one gear wheel (13, 22) is mountable at one end in the gear housing (11) and at the other end in a gear housing cover (12).
